(19) United States
(12) Patent Application Publication
(10) Pub. No.: US 2007/0208601 A1
(43) Pub. Date: Sep. 6, 2007

(54) SYSTEM FOR ENTERPRISE PERFORMANCE TRANSFORMATION

(76) Inventor: Arunkumar Ganapathi Pulianda, Flower Mound, TX (US)

Correspondence Address: Michael A. O'Nell;Michael A. O'Nell, P.C., Suite 820, 5949 Sherry Lane, Dallas, TX, 75225, US

(21) Appl. No.: 11/625,364

(22) Filed: Jan. 22, 2007

Related U.S. Application Data
(60) Provisional application No. 60/763,938, filed on Jan. 31, 2006.

(51) Int. Cl. G06F 9/44

(52) U.S. Cl. 705/7

(57) ABSTRACT

This invention generally relates to models and methods pertaining to strengthening the competitiveness of a business enterprise by transforming the efficiency and effectiveness of its SG&A (Selling, General& Administrative) functions like Information Technology, Finance & Accounting, Human Resources, Procurement and Supply Chain Operations, such transformation called ‘Enterprise Performance Transformation’. In particular, it relates to a ‘system’ for Enterprise Performance Transformation, consisting of (1) A scripted process to guide and govern all aspects of the Transformation and (2) A prescriptive Framework-of-Frameworks to orchestrate the process.

### CROSS-REFERENCE TO RELATED APPLICATION

This application claims priority of provisional application Ser. No. 60/763,938 filed Jan. 31, 2006, currently pending, the entire contents of which are incorporated herein by reference.

### TECHNICAL FIELD

The present invention relates to methods to advance the performance efficiency of a business enterprise. More particularly it applies to organizing and implementing a unique system, consisting of an integrated arrangement of prescriptive frameworks in association with a process, to enable a business enterprise to undertake systematic improvements to its operational capabilities and processes related to Selling, General and Administrative (SG&A) functions.

### BACKGROUND OF THE INVENTION

Businesses routinely undertake initiatives to improve SG&A operational capabilities to further their ability to compete, increase revenues and profit margins, expand into new markets, re-align their business structure, among many other reasons.

To achieve these goals, they perform, either utilizing their own staff or third party experts, or a combination of both, and utilizing manual efforts or automation, or a combination of both, a variety of actions, generally entailing:
a) Identifying business-reasons to alter Operational (i.e., SG&A) Capabilities, including processes, and the desired Operational Capability end-state
b) Assessing the current condition of one or more SG&A functions related to such Operational Capability
c) Determining a future-state for such SG&A functions to drive the desired Operational Capability end-state
d) Developing a plan-of-action to achieve the future-state for such SG&A functions
e) Utilizing one or more methods to measure, qualitatively and/or quantitatively, the Key Performance Indicators (KPI) of such SG&A functions during various stages of being altered
f) Implementing one or more initiatives and programs to execute the plan-of-action
g) Utilizing one or more methods to measure results from time-to-time and to implement further adjustments to the plan-of-action

Given the size of the global economy, the number of business enterprises in the industry and the criticality of SG&A robustness to the success of each business enterprise, there is much demand for services relating to items (a) through (g) above and consequently there are many providers of these services.

While the state-of-the-art continues to evolve, the services, expertise and the means of delivery currently available to business enterprises to align SG&A performance with changing business-needs suffer from one or more of the following limitations:
i. Designed as a point-solution and addresses a narrowly defined area or just one SG&A Function.
ii. Designed as a one-off remedy and can not accommodate changing conditions or criteria.
iii. Delivered in an ad-hoc manner utilizing the experiential knowledge of the individual(s) delivering the service and is therefore not repeatable, at least not easily.
iv. Does not scale to accommodate scenarios that were not envisioned at the time it was implemented or deployed.
v. Is very proprietary and can not be utilized without continued intervention by certain individuals or entities.
vi. Is limited in its ability to be integrated with supplementary and/or complementary services to achieve a more complete solution.
vii. Does not allow for strategic drivers to adjust the course and speed of changes underway.

These limitations often force business enterprises to settle for sub-optimal means and one-off Enterprise Performance Quick-fixes rather than pursue a more encompassing Enterprise Performance Transformation.

Enterprise Performance Transformation refers to ongoing adjustments to SG&A functions and associated capabilities such as Information Technology, Human Resources, Finance & Accounting and Supply Chain Management within business enterprises, to consistently ensure their ability to drive the larger business goals of the enterprise, such as Speed-to-market, rate-of-revenue-increase, size of market-share gain, and increase in profit-margins.

Enterprise Performance Transformation entails continuous improvements to the quality of an SG&A capability as typically measured by a variety of qualitative and quantitative indicators like unit costs, service levels, maturity levels, compliance accuracy, cycle-time quality and staff productivity.

Enterprise Performance Transformation necessitates a purposeful, systematic, programmatic, methodical, prescriptive, and integrated approach to adjusting the SG&A capabilities within a business enterprise.

The current invention overcomes several of the limitations presently preventing the achievement of Enterprise Performance Transformation in business enterprises. It does so by uniquely organizing a System for Enterprise Performance Transformation, consisting of a combination of an integrated arrangement of prescriptive Frameworks and a Process for Enterprise Performance Transformation.

### SUMMARY OF THE INVENTION

Provided is a unique system to achieve “Enterprise Performance Transformation” in business enterprises. The system consists of and derives from the integration of two components, (a) A Framework-of-Frameworks and (b) A Performance Transformation Process.

The preferred embodiment of the solution (i) requires the presence of both components of the system in the SG&A domain being the subject of Enterprise Performance Transformation. (ii) Also, the solution requires the necessary presence and use of the ‘Keystone Framework’ of the Framework-of-Frameworks suite. (iii) Also, the solution requires the necessary presence and use of one or more Extension Frameworks to achieve Domain Decomposition, Performance Calibration, Transformation Maturity and Performance Optimization. (iv) Further, the solution requires the presence and necessary use of the Performance Transformation Process in conjunction with the Framework-of-Frameworks. Finally, (iv) the solution may require customization and alteration of one or both components of the system prior to or during utilization, to accommodate the specific nature and needs of the Enterprise Performance Transformation being undertaken, including alteration of the methods, characterization of data, analysis and interpretation employed within one or more of the Frameworks in the Framework-of-Frameworks and/or the Performance Transformation Process. Such embodiment of the combination of prescriptive Frameworks and Process:
1. Establishes the means and mechanisms within the SG&A domain of the business enterprise to employ a programmatic approach for undertaking Enterprise Performance Transformation in that domain.
2. Enables standardization of one or several SG&A processes and functions which in turn reduces overheads associated with subsequent Enterprise Performance Transformation.
3. Provides the flexibility to integrate best-of-breed functional-capabilities from any number of in-house or external sources into the solution at any point in time, at minimal risk to the Enterprise Performance Transformation under way.
4. Accommodates use of business-strategy related measures, indicators and metrics to calibrate and govern the course and speed of changes to SG&A functions related to them.
5. Enables utilization of both qualitative and quantitative data and factors during the Enterprise Performance Transformation process.
6. Allows for use of technological capabilities to automate, streamline and structure one or more aspects of the Enterprise Performance Transformation effort.
7. Preserves for the business enterprise, options to continually alter the construction and arrangement of sub-components within the solution to keep the overall solution aligned with changes in the business.

### BRIEF DESCRIPTION OF DRAWINGS

FIG. 50 is an illustration of the conceptual Performance Model for a business enterprise wherein the overall performance of the enterprise is the aggregate of Business Performance item 56, the Enterprise Performance item 55 and the Process Performance item 54. Of particular relevance to the current invention for purposes of describing various embodiments is Operations, item 52, wherein all the SG&A functions of the enterprise are assumed to be physically orchestrated and the wherein the current invention is assumed to be organizationally deployed.

FIG. 100 is an illustration of the various ‘SG&A domains’ in the business enterprise and previously associated with item 52, item 59, item 60 and item 62 in FIG. 50.

FIG. 200 is an illustration of several embodiments of SG&A domains in a business enterprise and previously associated with item 52 in FIG. 50 and item 110, item 120, item 130, item 140, item 150 and item 160 in FIG. 100.

FIG. 225 is an illustration of the primary components of the Enterprise Performance Transformation system, with item 226 being the illustration for the prescriptive Framework-of-Frameworks and item 227 being the illustration for the governing Process for Enterprise Performance Transformation. Item 227 embodies a Primary-Process and one or more secondary-processes; each process in turn accommodates methods to execute its process steps.

FIG. 250 is an illustration of the structure of Framework-of-Frameworks and previously associated with item 226 in FIG. 225, with item 253 as the embodiment of the Keystone Framework, and item 251, item 252, item 254 and item 255 as embodiments of Extension Frameworks. Further, item 258, item 259, item 260 and item 261 are embodiments of linkages between and amongst the Frameworks and item 256 and item 257 are embodiments of linkages between the Strategy of the business enterprise to the Keystone Framework and an Extension Framework for purposes of providing direction and receiving results.

FIG. 275 is an illustration of the structure of a keystone Framework previously associated with item 253 in FIG. 250, the structure illustrating a multi-tier nested arrangement of elements starting with topmost elements embodied individually by item 276, the Dimension of the Framework, in turn consisting of elements embodied individually by item 277, an Utility, in turn consisting of elements embodied individually by item 278, the Stage, in turn consisting of elements embodied individually by item 279, Capability Category, in turn consisting of elements embodied individually by item 280, the Function-component.

FIG. 300 is an illustration of a preferred embodiment of the prescriptive Framework-of-Frameworks Component of the Performance Transformation System previously associated with item 226 in FIG. 225 and embodying a specific instance of the structure embodied in FIG. 250, with the Keystone Framework illustrated as the Transformation Acceleration Framework item 330, the associated Extension Framework illustrating the Domain Decomposition Framework embodied as item 310, The associated Extension Framework illustrating the Performance Calibration Framework embodied as item 320, the associated Extension Framework illustrating the Transformation Maturity Framework embodied as item 340 and the associated Extension Framework illustrating the Performance Optimization Framework embodied as item 350 respectively, the Strategy input embodied by item 51 and linkages to Strategy embodied by item 351 and item 352 respectively.

FIG. 400 is an illustration of several embodiments of dimensions associated with a Framework in general with a specific embodiment of the dimensions associated with the Transformation Acceleration Framework in item 253 in FIG. 250.

FIG. 450 is an illustration of four embodiments of dimensions of a Transformation Acceleration Framework associated with item 330 in FIG. 300.

FIG. 470 is an illustration of several embodiments of Keystone Framework Utilities associated with a Framework dimension item 276 in FIG. 275.

FIG. 500 is an illustration of an embodiment of four Utilities as in item 501, item 502, item 503, and item 504 respectively, associated with the Current State Assessment Dimension item 451 in FIG. 450.

FIG. 510 is an illustration of an embodiment of three Utilities as in item 511, item 512 and item 513 respectively, associated with the Internal Capability Deployment Dimension item 452 in FIG. 450.

FIG. 520 is an illustration of an embodiment of four Utilities as in item 521, item 522, item 523, and item 524 respectively, associated with the External Capability Deployment Dimension item 453 in FIG. 450.

FIG. 530 is an illustration of an embodiment of three Utilities as in item 531, item 532, and item 533 respectively, associated with the Knowledge And Skills Integration Dimension item 454 in FIG. 450.

FIG. 540 is an illustration of several Keystone Framework Roll-Out Stages associated with the embodiment of a Utility item 277 in FIG. 275.

FIG. 550 is an illustration of an embodiment of five Roll-out Stages as in item 551, item 552, item 553, item 554 and item 555 respectively, associated with the Transformation Maturity Audit Utility item 501 in FIG. 500.

FIG. 560 is an illustration of an embodiment of several Keystone Framework Capability Categories associated with an illustration of a Roll-Out Stage item 278 in FIG. 275.

FIG. 570 is an illustration of an embodiment of four Roll-Out Stage Capability Categories as in item 571, item 572, item 573, and item 574 respectively, associated with the PLAN Roll-Out Stage item 551 in FIG. 550.

FIG. 580 is an illustration of an embodiment of several Keystone Framework components associated with an illustration of a Capability Category item 280 in FIG. 275.

FIG. 590 is an illustration of an embodiment of four Capability Category Components as in item 591, item 592, item 593 and item 594 respectively, associated with the INTELLECTUAL PROPERTY Category item 572 in FIG. 570.

FIG. 2000 is an illustration of an embodiment of several levels of an SG&A Domain Decomposition Taxonomy of the Domain Decomposition Framework item 310 in FIG. 300, with item 2010 being the embodiment of the Root Level of the Taxonomy, item 2040 being the embodiment of the Second Level, item 2070 being the embodiment of the Third Level and item 2090 being the embodiment of the Fourth Level, respectively.

FIG. 2500 is an illustration of a Domain Decomposition Framework Taxonomy for a specific embodiment of an SG&A Domain, namely Human Resources Domain, the illustration serving as an example of the Taxonomy embodied in FIG. 2000.

FIG. 3000 is an illustration of an embodiment of several Performance Categories and several Key Performance Indicators (KPI) associated with the Performance Calibration Framework item 320 in FIG. 300, with item 3150 being the embodiment of a Performance Category and element ‘A1’ in column item 3010 being the embodiment of a Key Performance Indicator (KPI) respectively.

FIG. 3500 is an illustration of a Performance Calibration Framework for a specific embodiment of the illustration in FIG. 3000.

FIG. 3700 is an illustration of an embodiment of several derivations of Performance Metrics for Performance Category ‘A’ in item 3150 in FIG. 3000, with Metric ‘Aa’ in item 3820 derived via calculation Method illustrated in item 3730.

FIG. 3900 is an illustration of an embodiment of several derivations of Performance Metrics for Staff Productivity Performance category, item 3650 in FIG. 3500.

FIG. 4000 is an illustration of an embodiment of levels 1 through n of Transformation Capability Maturity for Maturity Dimensions 1 through n of the Transformation Maturity Framework item 350 in FIG. 300, with item 4070 being the embodiment of a ‘Maturity Level’, item 4010 being the embodiment of characterizations of Maturity Levels for ‘Maturity Dimension #1’, item 4060 being the illustration of an embodiment of ‘traits’ associated with a Maturity Level for a Maturity Dimension.

FIG. 5000 is an illustration of several embodiments of Performance Optimization Framework Scorecards for the Performance Optimization Framework, item 340 in FIG. 300.

FIG. 5500 is an illustration of six embodiments of Performance Scorecards for the Performance Optimization Framework 340 in FIG. 300, with item 5510 being the embodiment of the Scorecard for Staff Productivity, item 5520 being the embodiment of the Scorecard for Cost Effectiveness, item 5530 being the embodiment of the scorecard for Process Efficiency, item 5560 being the embodiment of the scorecard for Sourcing Governance, item 5550 being the embodiment of Scorecard for Service Delivery and item 5540 being the embodiment of the scorecard for SOX Compliance.

FIG. 6000 is an illustration of an embodiment of the Process For Enterprise Performance Transformation, the embodiment integrating and utilizing various methods and also items associated with figures covered earlier in this section.

FIG. 7000 is an illustration of one Method among several, in the Process For Enterprise Performance Transformation in FIG. 6000, the ‘Establish Current State’ step in item 6310, the embodiment utilizing and integrating items previously associated with figures covered earlier in this section.

### DETAILED DESCRIPTION

The detailed description herein along with references to drawings will be an attempt to fully describe the best mode of practicing the invention at this time. While it will be described in connection with presently preferred embodiments, it will be understood that it is not intended to limit the invention to those embodiments. On the contrary, it is intended to cover all alternatives, modifications, means of delivery and equivalents included within the spirit of the invention.

For ease of illustration, assume that the invention is employed within a ‘UNIT’ of business enterprise, one that is not restricted by necessary size in revenue, geographical dispersion or staff strength, and embodies the conditions and characteristics required to beneficially utilize the current invention. Some examples of such an enterprise ‘UNIT’ are Merrill Lynch, a financial services institution; American Airlines, a transportation services company; General Motors, an Automobile company; Starbucks, a Consumer Products company; Clarke American, a small specialty services company; and Dow Jones, a publishing company. Smaller business-divisions within a business enterprise also qualify as a ‘UNIT’.
Also, for ease of illustration, assume that the UNIT, wherein the invention is deployed, is internally organized with the following implicit or explicit structure:

People, procedures and functions representing and responsible for Business Strategy planning and execution.
People, procedures and functions representing and responsible for Operations planning and execution.
People, procedures and functions representing and responsible for Systems planning and execution.

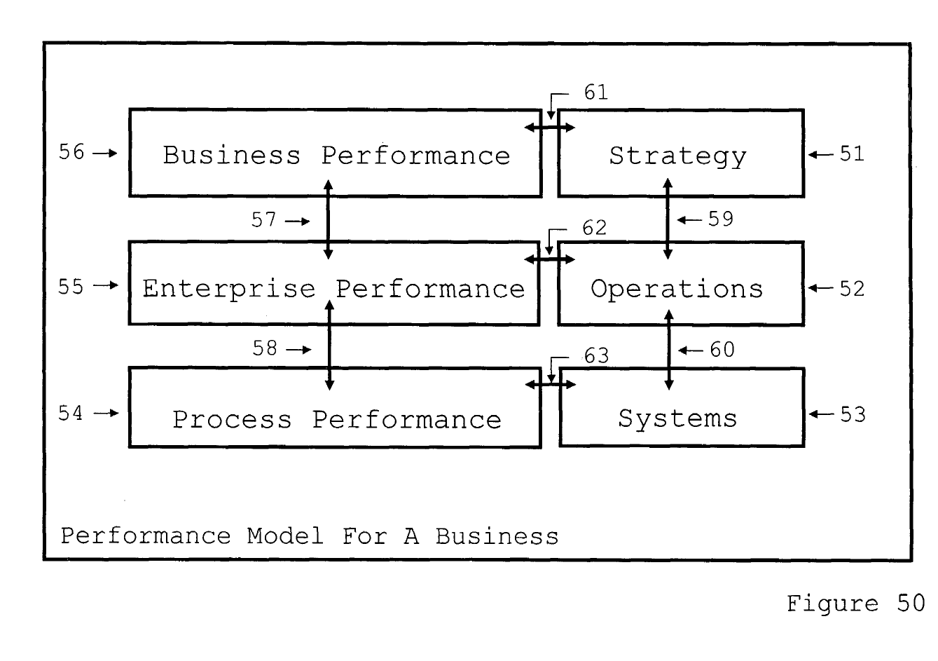

FIG. 50 embodies the illustration wherein item 51 represents the ‘Strategy’ structure, item 52 represents the ‘Operations’ structure and item 53 represents the ‘Systems’ structure.

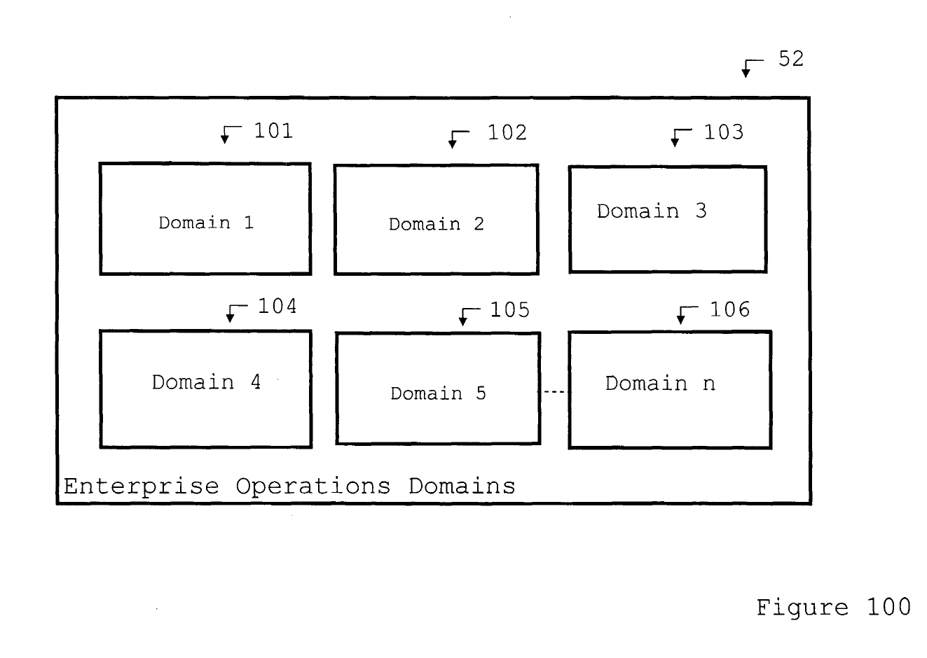

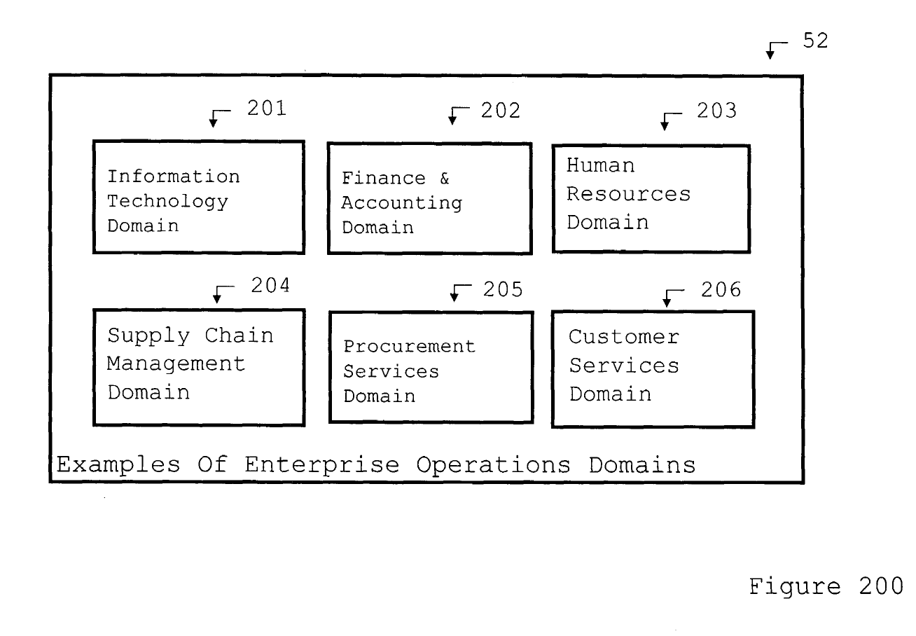

Also, for ease of illustration, assume that:
The ‘Strategy’ structure of the UNIT is further comprised of some form of a Business-Performance-Management competency, either formalized or informal, the purpose of which is to ensure that the business enterprise achieves its goals, and is aligned with Business Strategy. This is also embodied as item 51 in FIG. 50.
The ‘Operations’ structure of the UNIT is further comprised of collections-of-functions, familiar to those knowledgeable in the art as SG&A (Selling, General & Administrative) functions and domains. These include but are not limited to people, resources, procedures, decision-making and performance of areas such as Information Technology (IT), Finance, Accounting, Human Resources (HR), Supply Chain, Procurement and Customer Support. This is also embodied as item 52 in FIG. 50 and illustrated in a general embodiment as item 101, item 102, item 103, item 104, item 105 and item 106 in FIG. 100. Further, this is also illustrated as specific embodiments in item 201, item 202, item 203, item 204, item 205 and item 206 in FIG. 200.
The ‘Systems’ structure of the UNIT is further comprised of technology, computer systems, telecommunications, connections, software, algorithms and such, required to establish, operate and achieve ‘Process Performance’—i.e., end-to-end results for the various processes that in total make up the SG&A capability of the business enterprise. This is also embodied as item 53 in FIG. 50.

Also, for ease of illustration, assume that:
The efficiency and effectiveness of the ‘Strategy’ structure, item 51, is conceptually viewed in aggregate as constituting ‘Business Performance’, is associated with item 56 and is coupled via various mechanisms represented by item 61 to the people, procedures and functions representing and responsible for Business Strategy Planning and Execution, item 51 in FIG. 50.
The efficiency and effectiveness of the ‘Operations’ structure, item 52, is conceptually viewed in aggregate as constituting ‘Enterprise Performance’, is associated with item 55 and is coupled via various mechanisms represented by item 62 to the people, procedures and functions representing and responsible for Operations Planning and Execution, item 52 in FIG. 50.
The efficiency and effectiveness of the ‘Systems’ structure, item 53, is conceptually viewed in aggregate as constituting ‘Process Performance’, is associated with item 54 and is coupled via various mechanisms represented by item 63 to the people, procedures and functions representing and responsible for Systems Planning and Execution, item 53 in FIG. 50.

Also, for ease of illustration, assume that, in an optimal working state, of the UNIT:
The ‘Systems’ structure of the UNIT is aligned with the ‘Operations’ structure it needs to manifest and support.
The ‘Operations’ structure of the UNIT is aligned with the ‘Strategy’ structure it needs to manifest and support.

The context for the best mode of practicing the invention can be further established by assuming that:
The ‘Strategy’ structure of the UNIT, associated with item 51 in FIG. 50, has determined that Business Performance item 56, articulated via appropriate mechanisms associated with item 61 in FIG. 50, is not in-line with expectations and that a change in status-quo is warranted.
The ‘Operations’ structure of the UNIT, associated with item 52 in FIG. 50, in turn determines that, in order to achieve the desired change in status-quo in ‘Strategy’ item 51 in FIG. 50, ‘Enterprise Performance’, item 55 in FIG. 50 articulated via appropriate mechanisms associated with item 62 in FIG. 50 also needs to change, and further that these changes are warranted in the ‘domains’ constituting the individual and collective representation of capabilities of the ‘Operations’ structure, i.e., the SG&A functions/domains.
Subsequent to, consequent to, and commensurate with initiation of changes, collectively represented as initiation of Enterprise Performance Transformation, the UNIT may initiate changes to ‘systems’ associated with item 53, as manifested, via appropriate mechanisms associated with item 63 in FIG. 50, as ‘Process Performance’ associated with item 54 in FIG. 50.
A set of appropriate mechanisms associated with item 57, item 58, item 59 and item 60 in FIG. 50 will be utilized to disseminate information and content related to the events associated with Enterprise Performance Transformation so as to Create a Feedback System.

Following is a description of the System For Enterprise Performance Transformation.

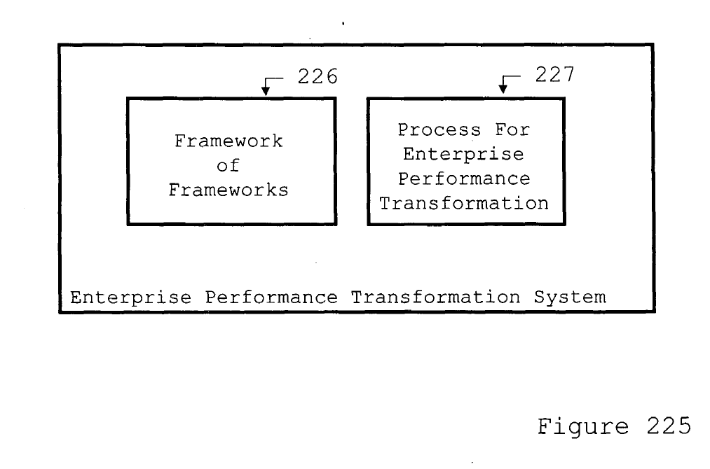

An illustration of the preferred embodiment of The System For Enterprise Performance Transformation is shown in FIG. 225. Such system consists of two primary components—A prescriptive Framework-of-Frameworks and a Process for Enterprise Performance Transformation.

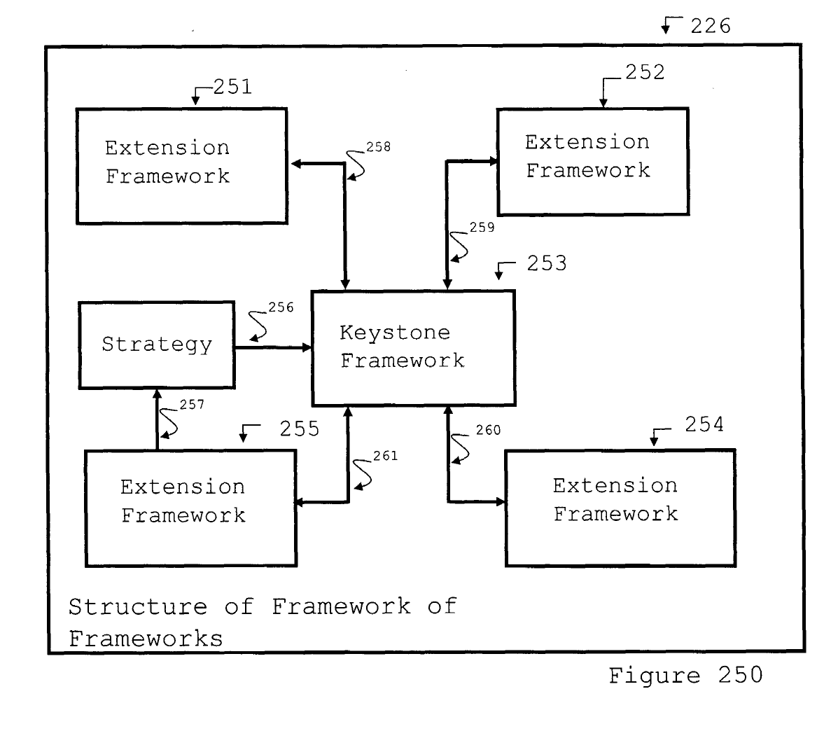

The Framework-of-Frameworks associated with item 226 in FIG. 225 and FIG. 250 is a suite of individual Transformation Frameworks, each Framework in the suite representing and performing different specialized operations to achieve a whole that is greater than the sum of the individual operations of individual Frameworks.

A preferred embodiment of the structure of Framework-of-Frameworks is illustrated in FIG. 250:
At minimum it consists of a Keystone Framework. The keystone Framework manifests the centrality of artifacts, intellectual-property, algorithms, calculations, models, methods, tools, etc. to achieve the required transformation under the control and direction of the governing ‘Process For Enterprise Performance Transformation’ associated with item 227 in FIG. 225.
Additionally, unless the Keystone Framework or another Framework has been alter to equip it with equivalent or substitute capabilities, it must also include the Extension Frameworks associated with item 251, item 252, item 254 and item 255. These Frameworks perform specialized roles and operations such as organizing a taxonomy for the various functions in an SG&A domain, establishing industry-standard indicators and metrics for various performance categories, enabling the structure and guidelines to improve the maturity of a business process or SG&A domain, facilitating the creation of various scorecards and dashboards to organize, and to view and share a variety of performance data.
Further, it must include mechanisms associated with item 258, item 259, item 260 and item 261 or their equivalents, for connection and communication between and amongst the various Frameworks in FIG. 250.
Also, it must include a mechanism associated with the embodiment of item 256 and item 257, to receive inputs from and deliver outputs to, the Strategy structure of the UNIT.

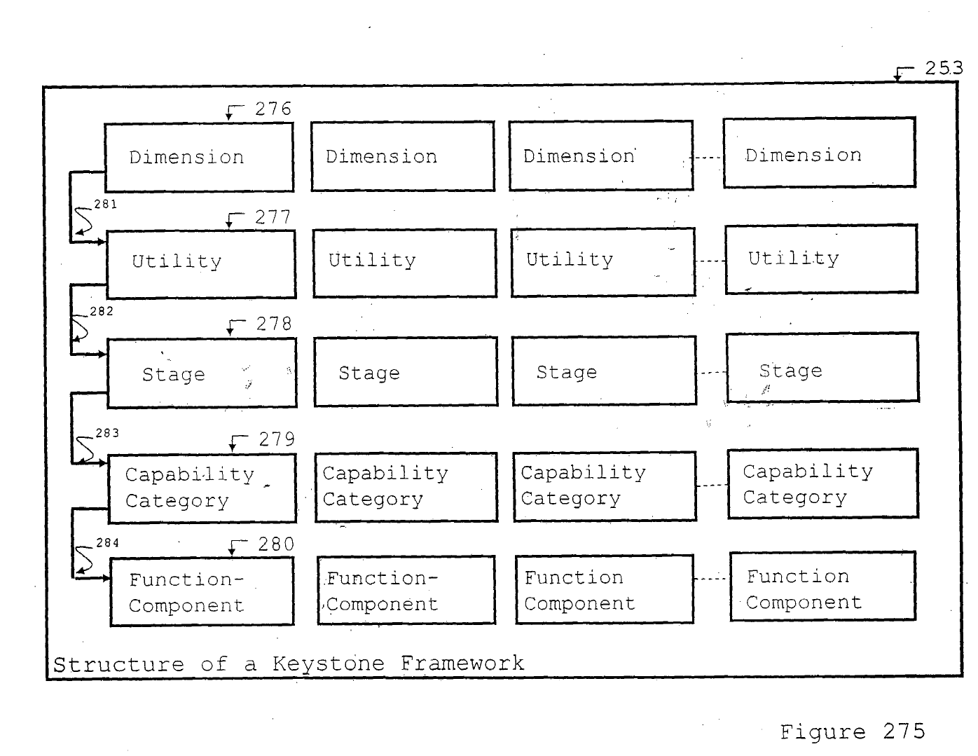

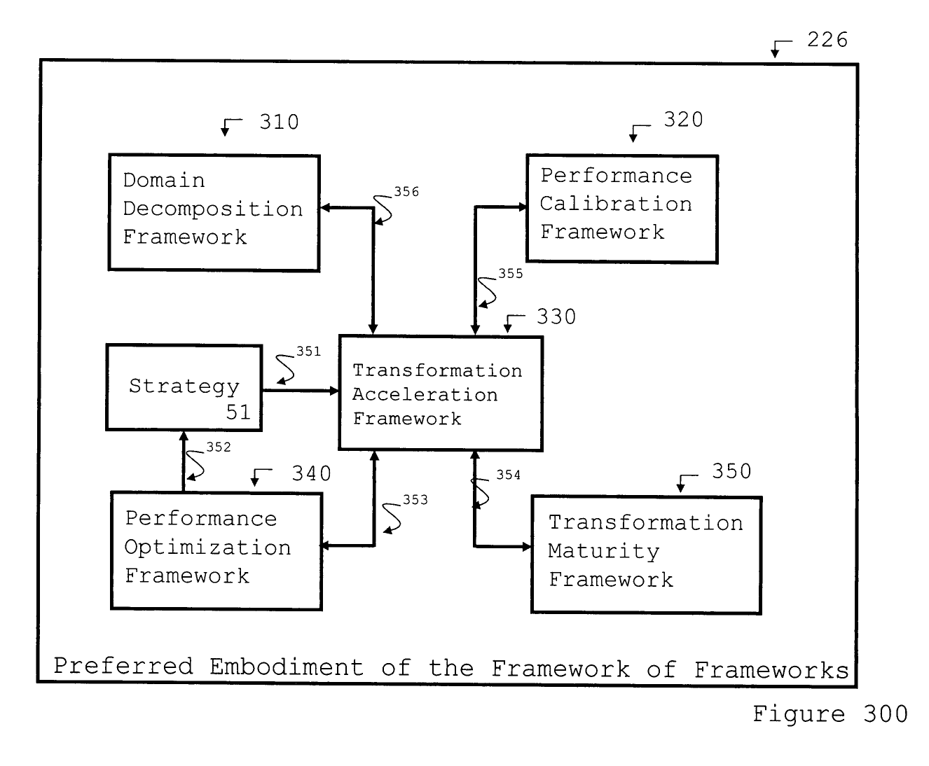

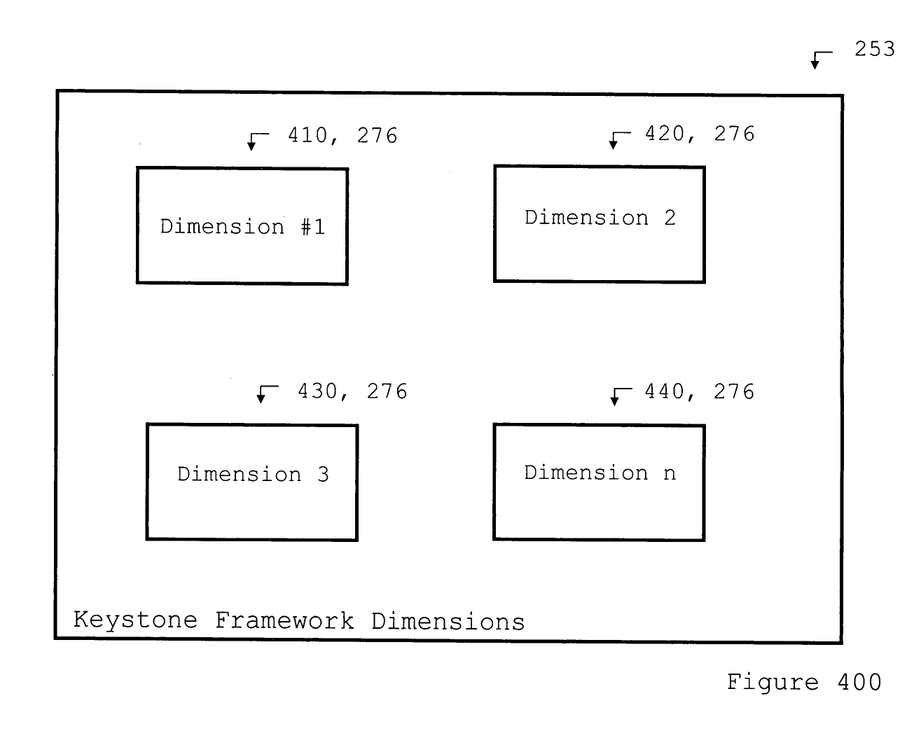

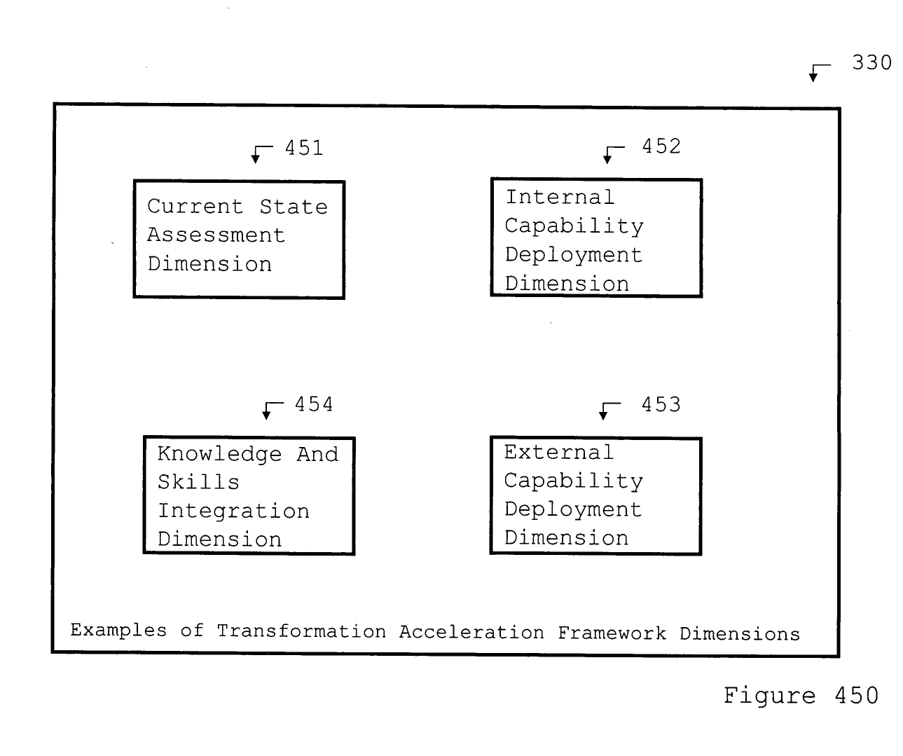

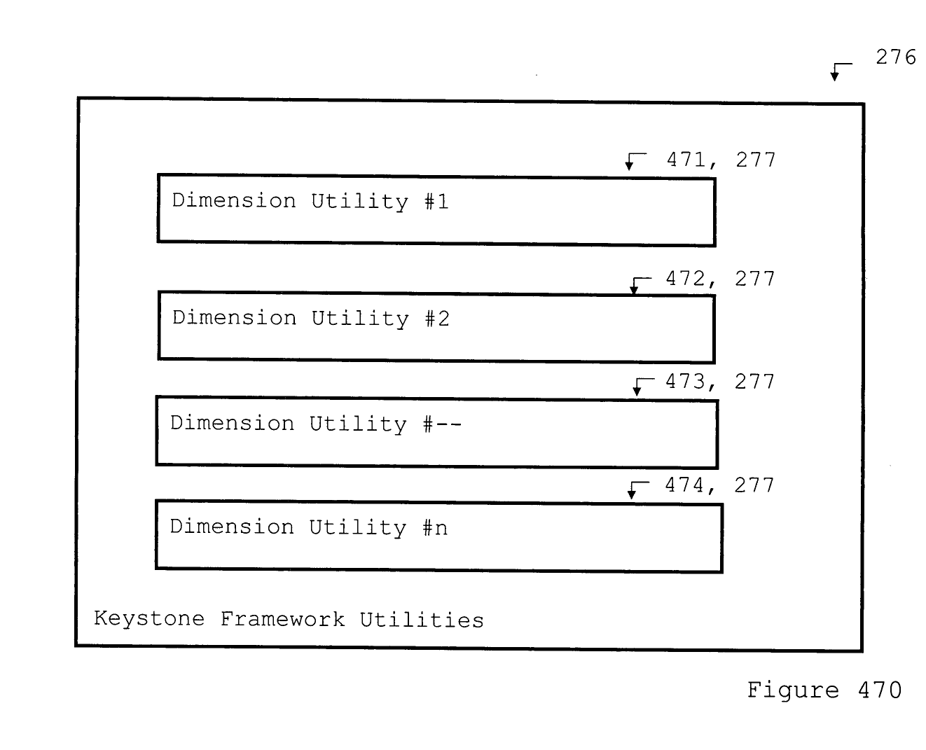

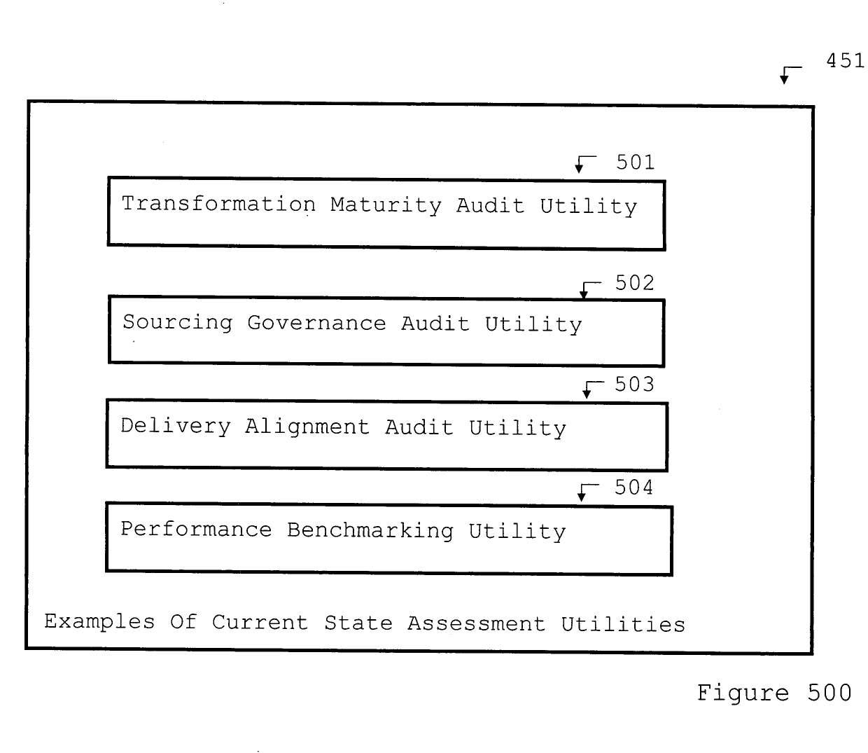

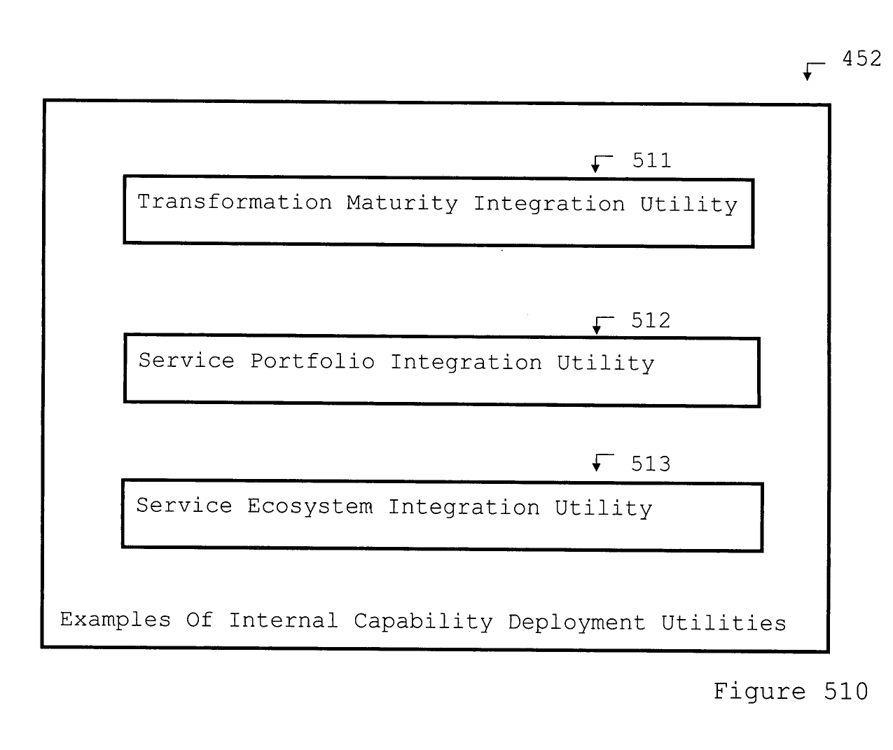

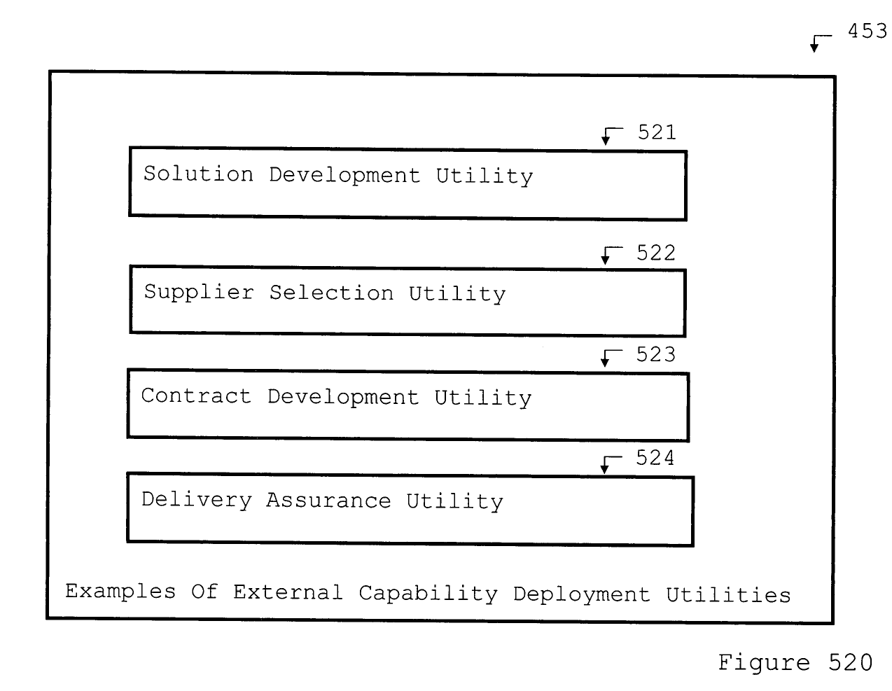

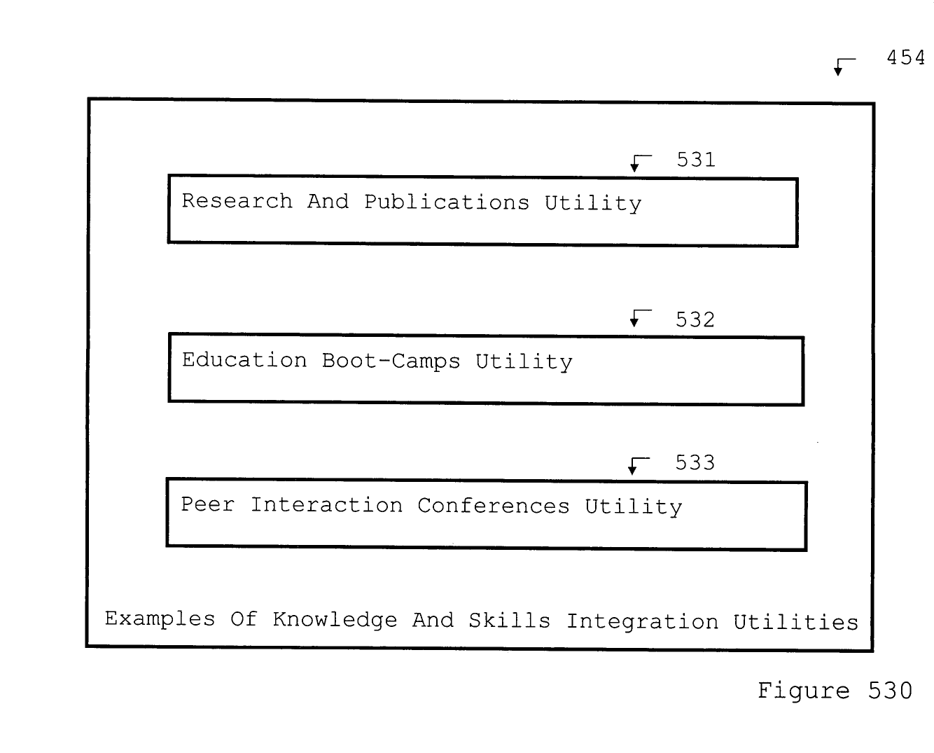

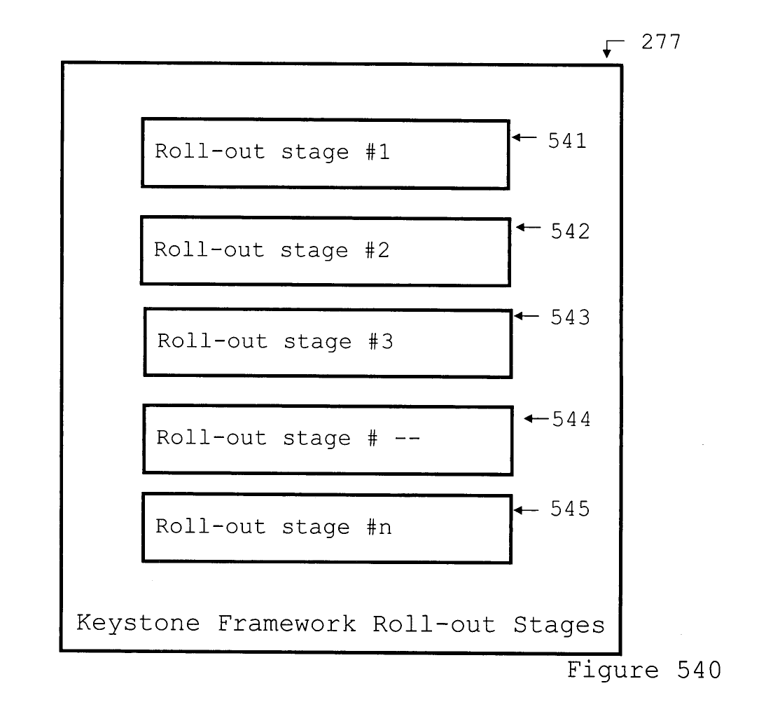

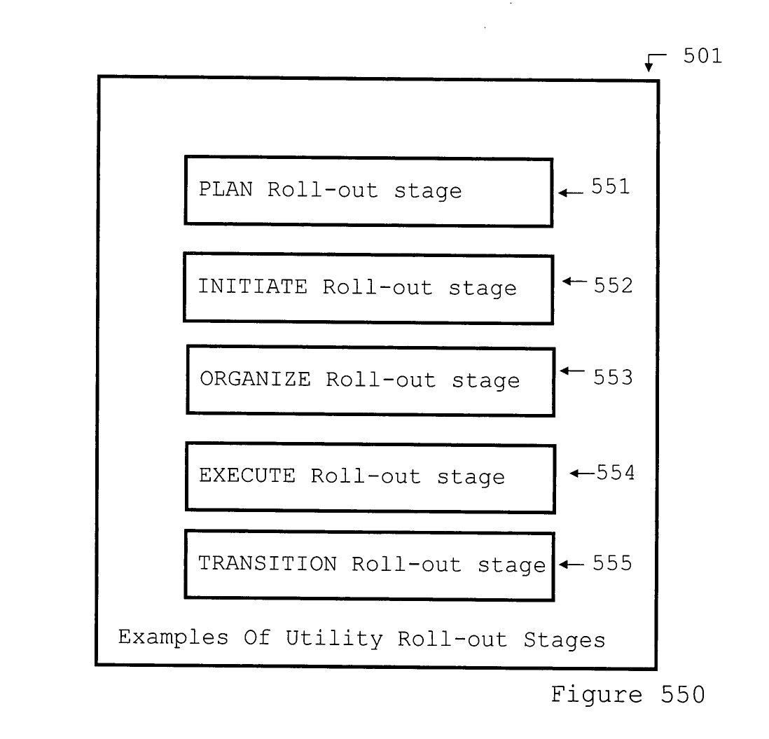

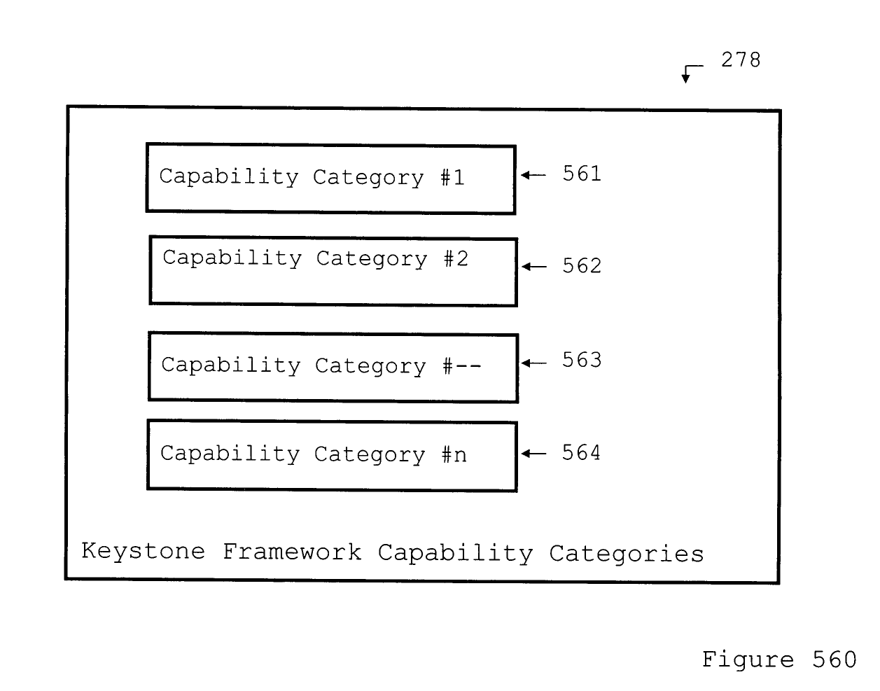

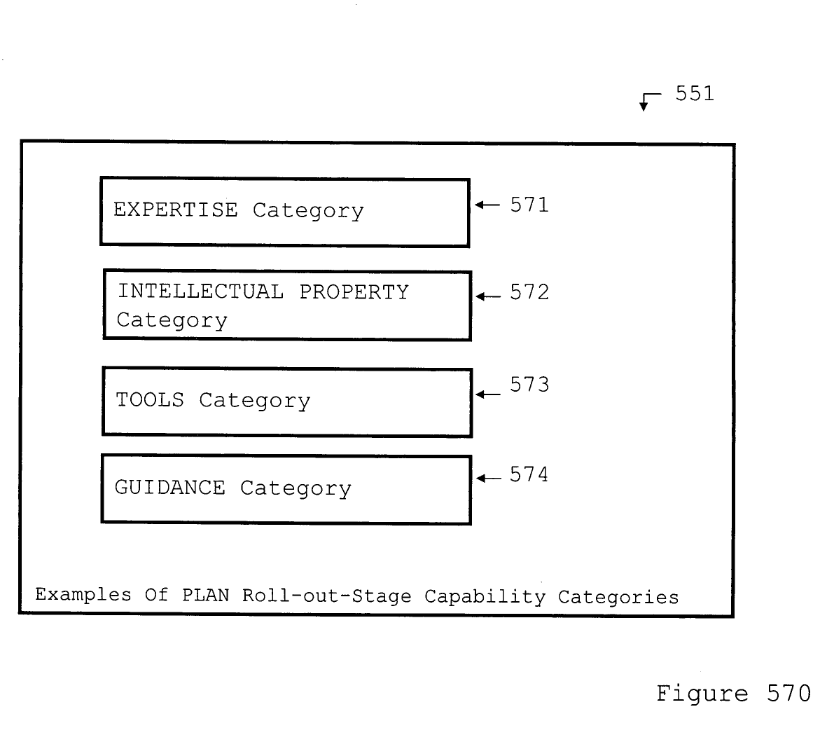

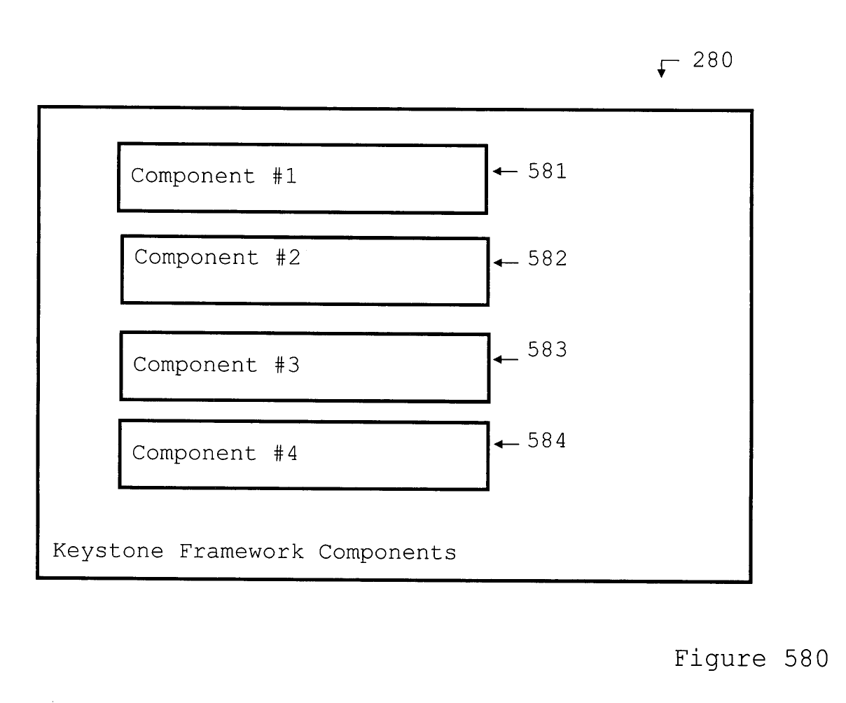

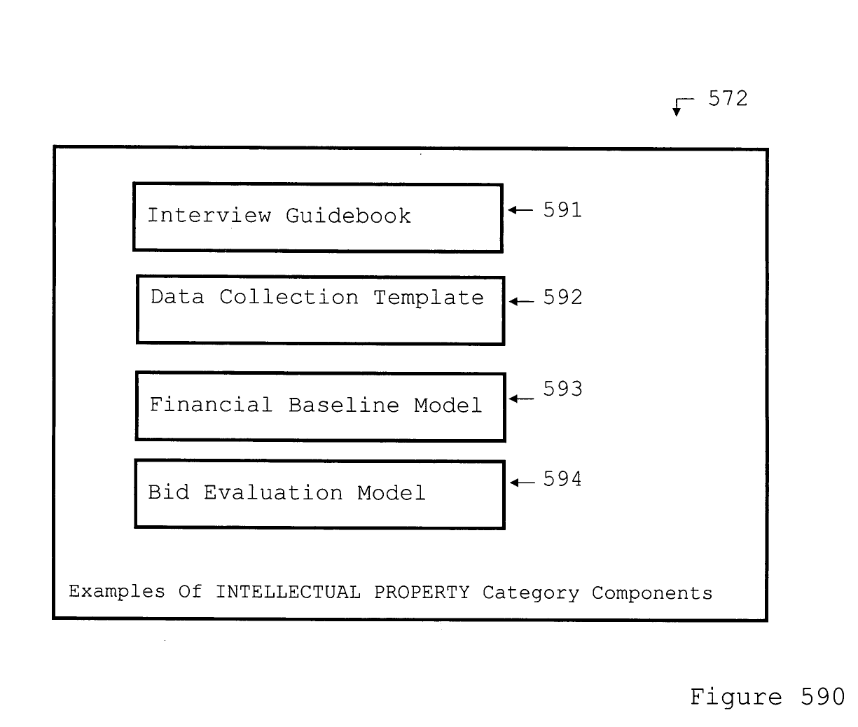

The Keystone Framework associated with item 253 in FIG. 250 is further organized with a preferred embodiment illustrated in FIG. 275, and illustrated further in embodiments in FIG. 300, FIG. 400, FIG. 450, FIG. 470, FIG. 500, FIG. 510, FIG. 520, FIG. 530, FIG. 540, FIG. 550, FIG. 560, FIG. 570, FIG. 580 and FIG. 590:
The Framework consists of any number of Dimensions, associated individually with item 276, item 410 in FIG. 400 and item 451 in FIG. 450. A Dimension is analogous to one leg of a travel journey, one segment of an airline travel etc. and provides the major building blocks for the entire Enterprise Performance Transformation Journey.
Each Dimension involves any number of Utilities, associated individually with item 277, item 471 in FIG. 470, items in FIG. 500, FIG. 510, FIG. 520 and FIG. 530. A utility is analogous to a procedural capability to measure distance between two cities during a journey or the precise flight path within a travel leg or flight segment.
Each Utility consists of any number of Roll-out Stages, associated individually with item 278, item 541 in FIG. 540, and items in FIG. 550. An example of a stage is the PLANNING stage for the journey or the INITIATE stage for a flight plan.
Each Utility requires the use of any number of capability categories, associated individually with item 279, item 561 in FIG. 560, and item 571 in FIG. 570 to achieve its goals. An example of a capability category is the TOOLS capability exemplified by either a road-GPS system or a sophisticated cockpit navigation system.
Finally, each Capability category for each Roll-out Stage employs the use of any number of Function-Components, associated individually with item 280, item 581 in FIG. 580 and item 591 in FIG. 590. An example of a Function-Component for the PLANNING Stage of a journey is database of distances between cities.

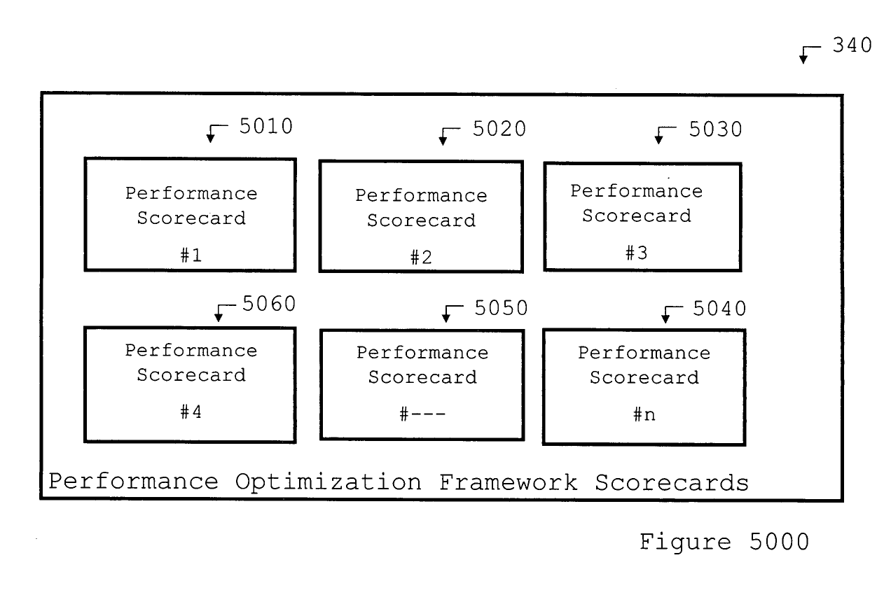

FIG. 300 also illustrates the preferred embodiment of the Framework-of-Frameworks with the utilization of the Keystone Framework embodied by the Transformation Acceleration Framework, associated with item 330. The preferred structure:
Employs the Transformation Acceleration Framework item 330 to provide the capabilities and responsibilities expected of the Keystone Framework for Enterprise Performance Transformation in SG&A domains.
Employs the Domain Decomposition Framework item 310 as an Extension Framework, to provide the capabilities to establish a ‘taxonomy’ for the various functions and processes in a particular SG&A domain.
Employs the Performance Calibration Framework item 320 as an Extension framework, to derive the performance indicators and Metrics associated with various SG&A functions and processes.
Employs the Transformation Maturity Framework item 350 as an Extension Framework to enable one or more Maturity Models to diagnose and guide the maturity of one or more SG&A functions and processes.
Employs the Performance Optimization Framework item 340 as an Extension Framework to organize, present, analyze, disseminate and report various parameters and derivations pertaining to the ongoing state of the Enterprise Performance Transformation journey of SG&A functions and processes. This Framework may also participate in a system which is ‘enabling’ the various life-cycle stages of pertinent SG&A functions and processes, may exchange inputs and responses during various enablement-life-cycle stages, eventually incorporating these within scorecards and dashboards embodied in FIG. 5000.
Employs inputs from and provides ongoing feedback to the ‘Strategy’ structure item 51 of FIG. 50.
Employs various connection and communication mechanisms embodied by the illustrations associated with item 351, item 352, item 353, item 354, item 355 and item 356.

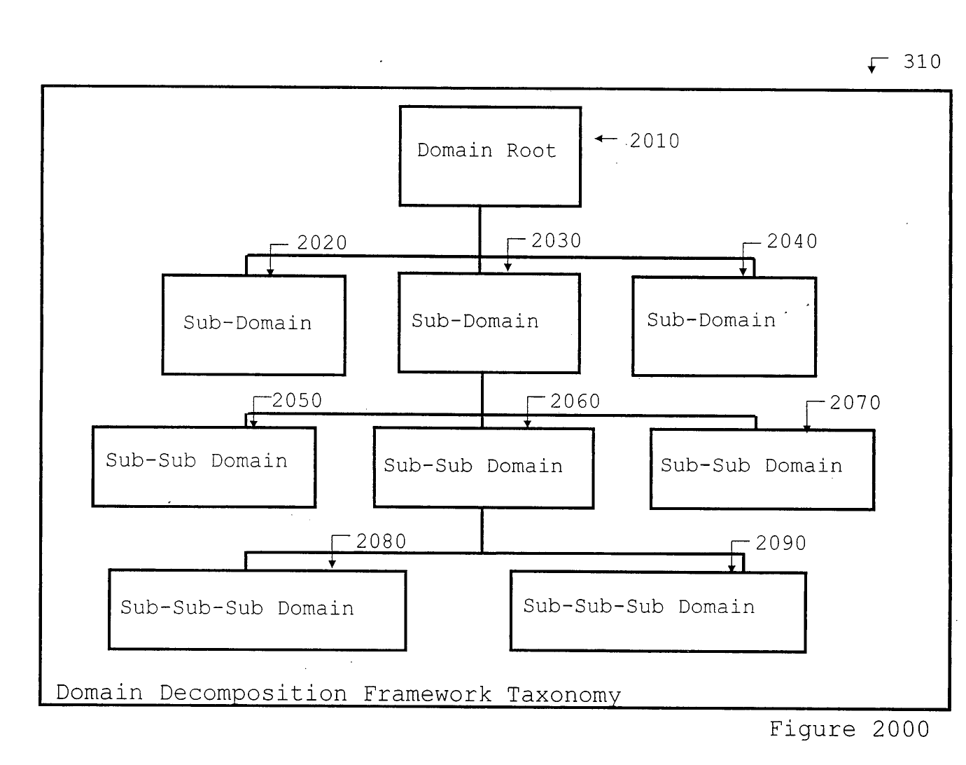

FIG. 2000 illustrates an embodiment of an Extension Framework, previously associated with item 251 in FIG. 250. Further, it illustrates a specific preferred embodiment associated with item 310 in FIG. 300 wherein it provides the taxonomy for decomposition of an SG&A function/domain into its constituent parts as is recognized by those with familiarity in the art and which is further associated with the Keystone Framework embodied by the Transformation Acceleration Framework item 330 via the mechanisms embodied by the illustrations of item 356.

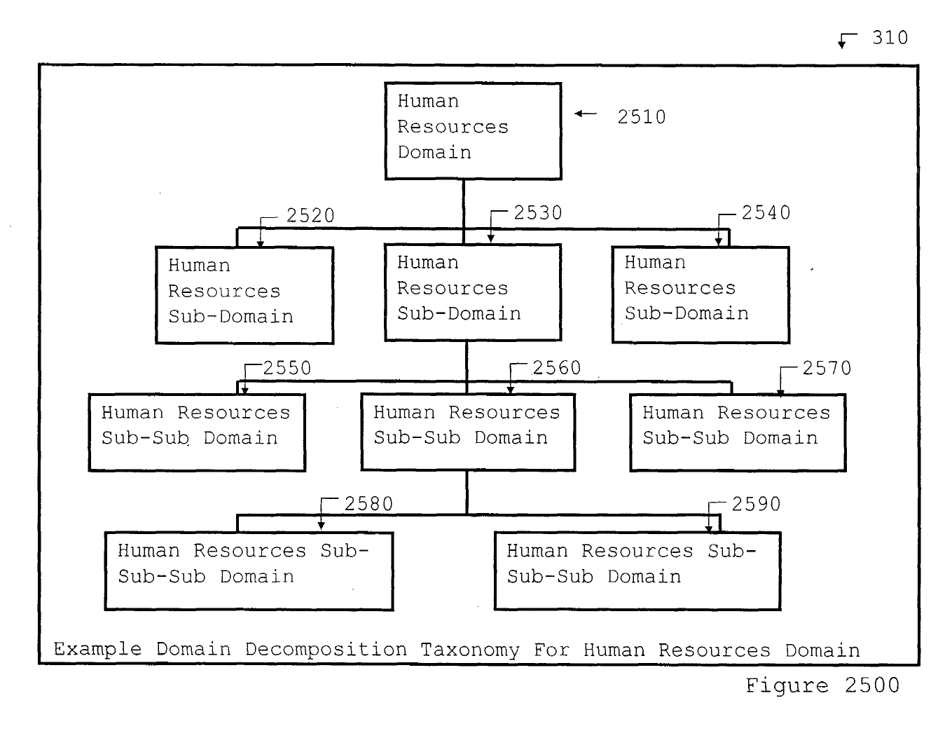

FIG. 2500 illustrates an example of the embodiment of the Framework illustrated in FIG. 2000 and described earlier.

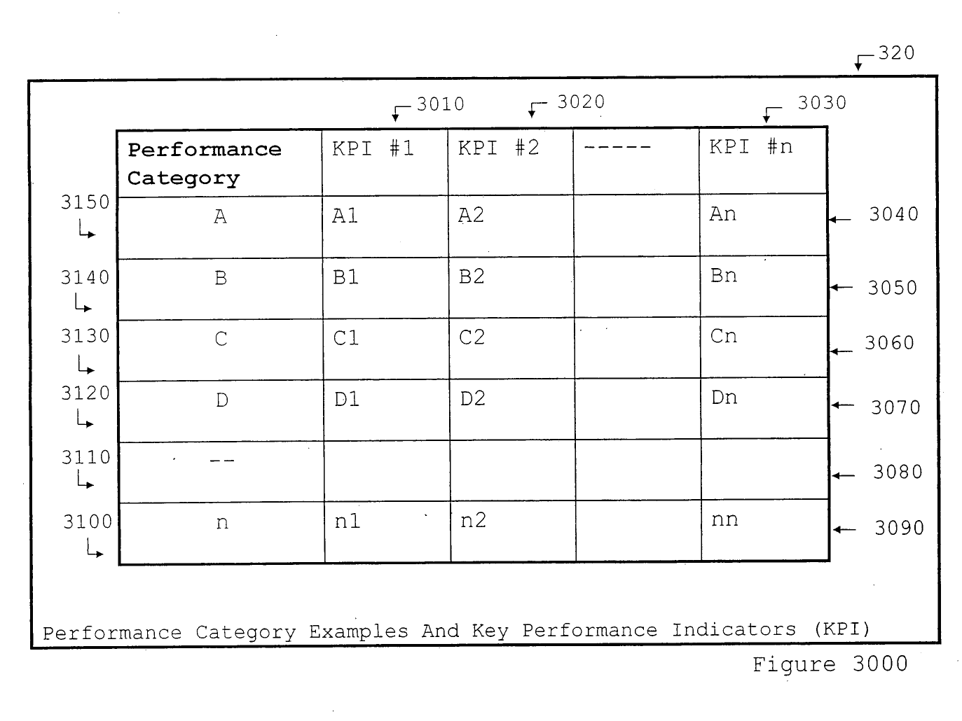

FIG. 3000 illustrates an embodiment of an Extension Framework, previously associated with item 320 in FIG. 300 wherein it provides a template format for organizing key Performance Indicators (KPI) associated individually with representative item 3010 for various Performance Categories associated individually with representative item 3150.

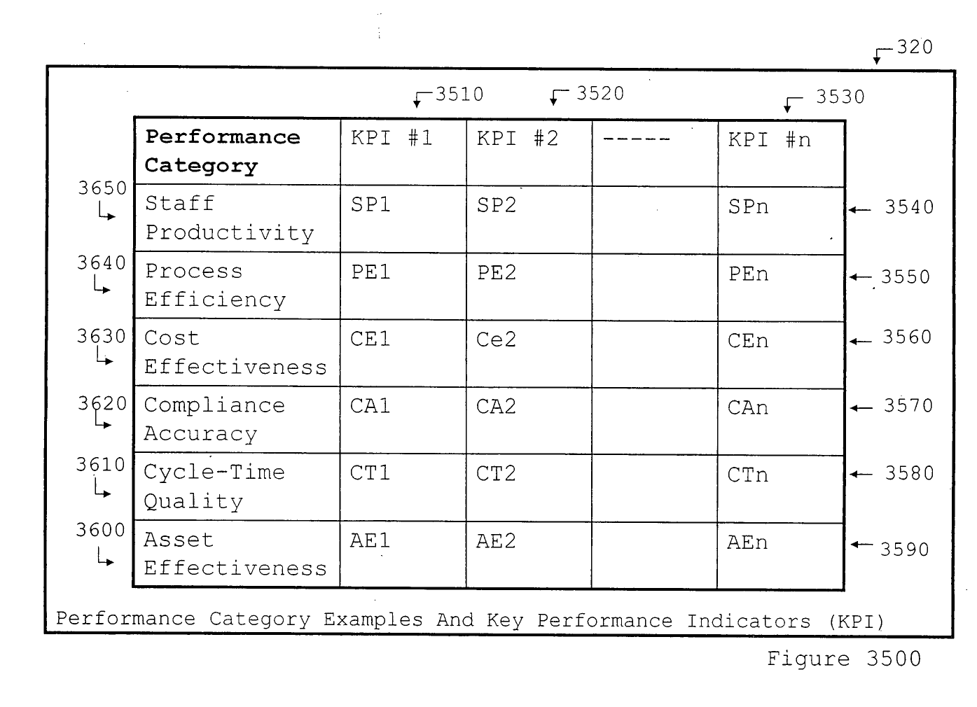

FIG. 3500 illustrates an embodiment of the Framework illustrated in FIG. 3000 and described earlier.

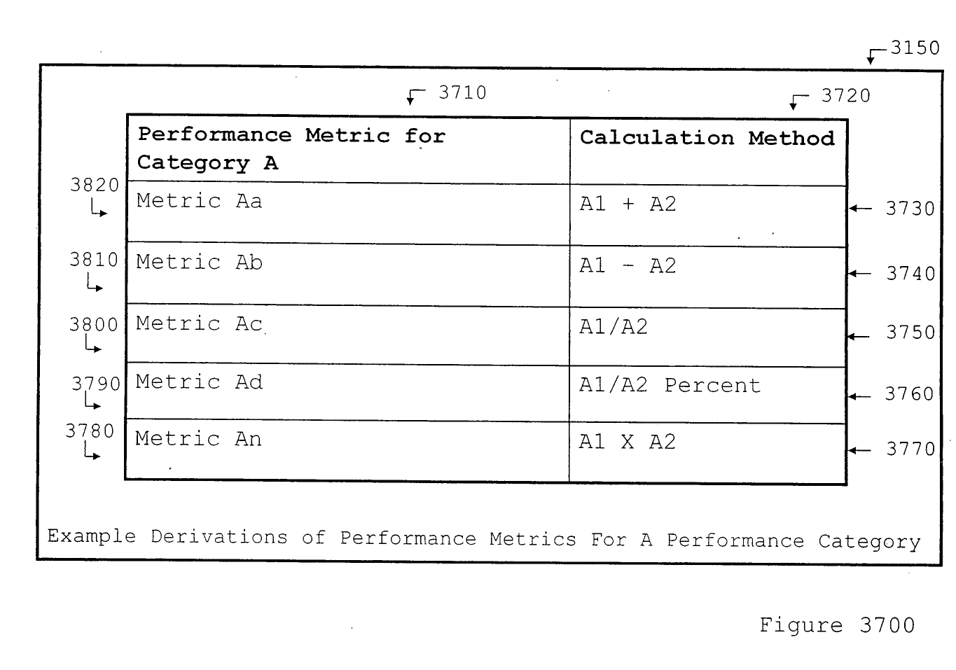

FIG. 3700 illustrates an embodiment of the mechanism to calculate specific Performance Metrics within the embodiment of the Extension Framework associate with FIG. 3000, wherein item 3710 is an embodiment of the Performance Metric Category, item 3720 is an embodiment of the Calculation method for such Metrics, item 3820 is an embodiment of an individual Metric and item 3730 is an embodiment of the calculation approach for said metric.

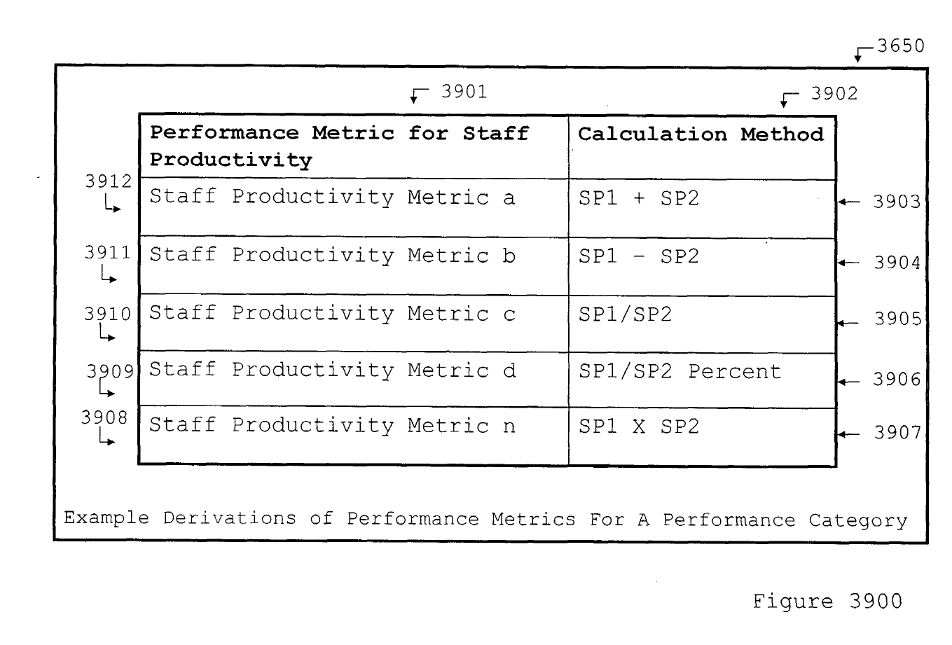

FIG. 3900 illustrates an embodiment of FIG. 3700 with additional specificity provided for the embodiments of the illustrations for each Metric item in FIG. 3700.

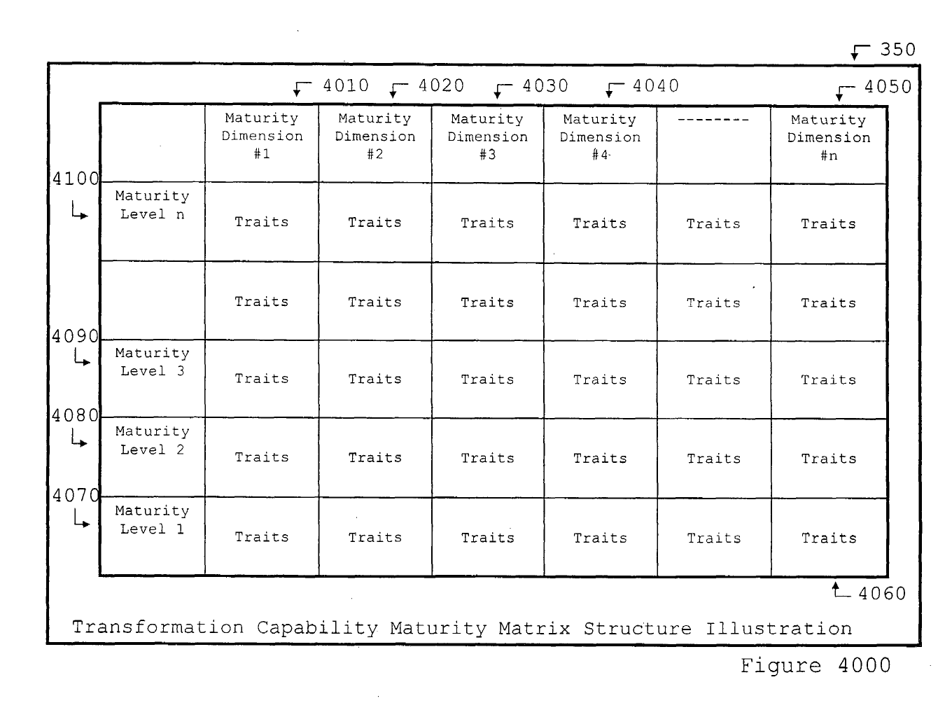

FIG. 4000 illustrates an embodiment of an Extension Framework, previously associated with item 254 in FIG. 250. Further, it illustrates a specific preferred embodiment associated with item 350 in FIG. 300 wherein it presents a Transformation Maturity Scorecard with dimensions of maturity illustrated by representative embodiment in item 4010 and with Maturity levels illustrated by representative embodiment in item 4100.

FIG. 5000 illustrates an embodiment of an Extension Framework, previously associated with item 255 in FIG. 250. Further, it illustrates a specific preferred embodiment associated with item 340 in FIG. 300 wherein it organizes a suite of Performance Scorecards as illustrated by representative embodiment in item 5010.

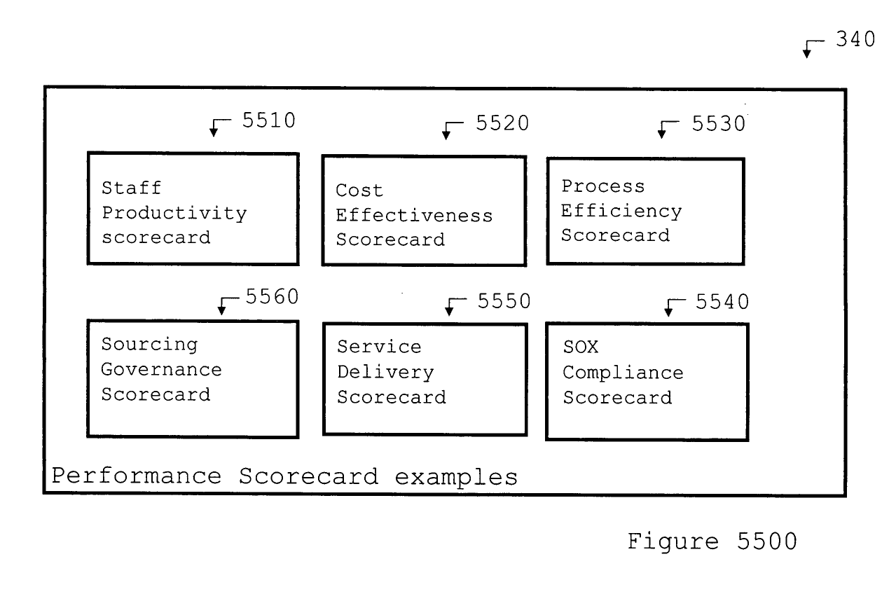

FIG. 5500 illustrates an embodiment of FIG. 5000 with additional specificity provided for the embodiments of the illustrations for each scorecard item in FIG. 5000.

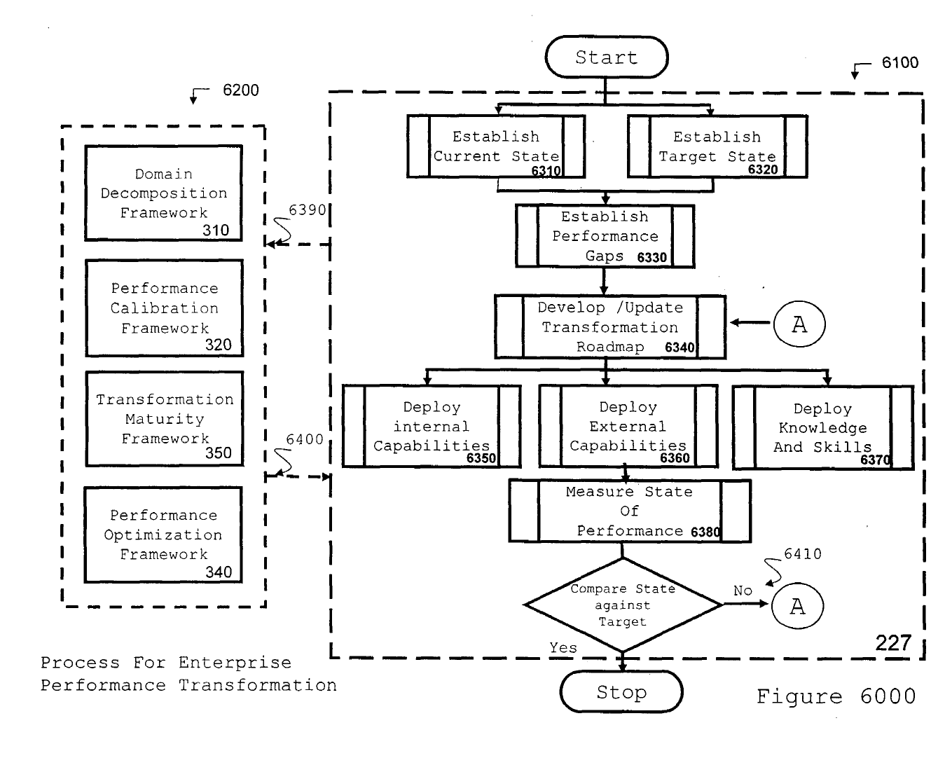

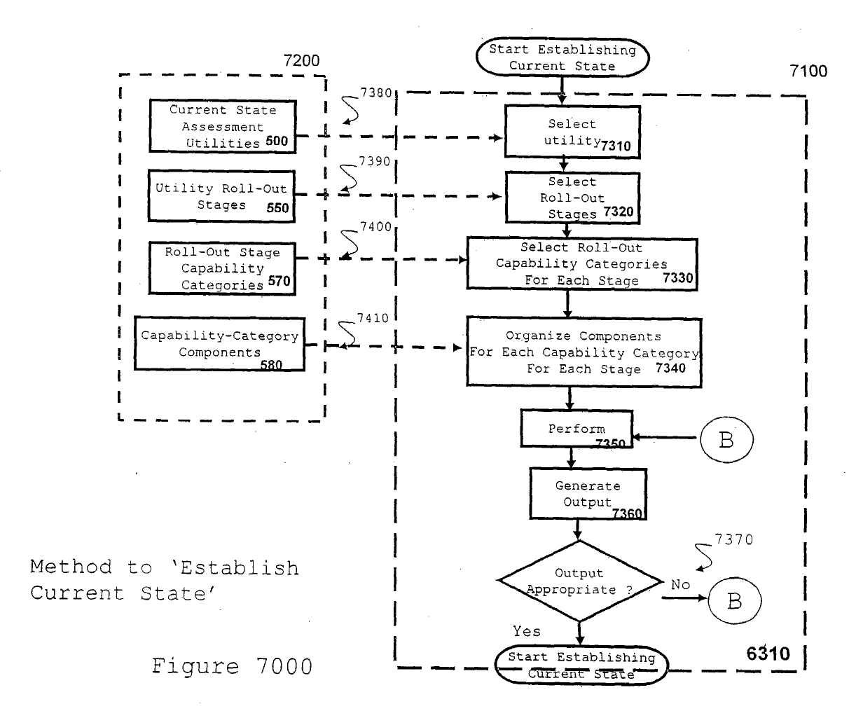

With the need for Enterprise Performance Transformation established in a UNIT earlier herein, the preferred mode of practicing the invention at this time requires that, as the very first step, the Process For Enterprise Performance Transformation is invoked as embodied in item 227 in FIG. 225 and as illustrated by a preferred embodiment in FIG. 6000. Immediately next, this Primary-Process summons the Keystone Framework which in addition to applying its own capabilities, summons the capabilities of the individual Frameworks in the Framework-of-Frameworks to accomplish results. The Primary-Process-flow is illustrated as embodied by constituent steps and methods associated with item 6100. The Primary-Process-flow invokes the participation of and contributions from the involved Extension Frameworks under the governance and supervision of the Keystone Framework as illustrated by a preferred embodiment in item 6200. The Primary-Process-flow:
Invokes the Keystone Framework which immediately utilizes its own capabilities as illustrated by embodiments in FIG. 275 to:
Establish the Current State of the in-scope SG&A function/domain through the use of its constituent Dimensions, Utilities, Stages, Capability categories and Function-Components as well as through the invocation of Extension Frameworks as appropriate, as embodied by item 6310 in FIG. 6000. FIG. 7000 illustrates an embodiment of a method or secondary-process, utilized by the Primary-Process to establish the Current State:
   The method is invoked by the Primary-Process step embodied by item 6310 in FIG. 6000.
   The method selects the appropriate Utilities to undertake the task as embodied by item 7310 in FIG. 7000 from a collection of Utilities intended for the purpose and available, as illustrated by item 500 in item 7200 in FIG. 7000.
   The method selects the Roll-Out stages for each of the selected utilities as embodied by item 7320 in FIG. 7000 from a collection of Stages intended for the purpose and available, as illustrated by item 550 in item 7200 in FIG. 7000.
   The method selects The Roll-Out Capability categories for each Stage as embodied by item 7330 in FIG. 7000 from a collection of Roll-Out Stage Capability Categories intended for the purpose and available, as illustrated by item 570 in item 7200 in FIG. 7000.
   The method organizes Components for each capability category for each stage as embodied by item 7340 in FIG. 7000 from a collection of Capability Category Components intended for the purpose and available, as illustrated by item 580 in item 7200 in FIG. 7000.
   With the required intellectual-property content and tools at its disposal, the method then facilitates the performance of the actual process actions as embodied in item 7350 in FIG. 7000. These actions could be performed by individuals either manually or by use of technology or other means as applicable to the circumstance.
   The method then facilitates the generation of outputs as illustrated in item 7360 in FIG. 7000.
   The method then compares the output against pre-determined or periodically determined profile to either continue the process as embodied by item 7370 or, upon successful completion, return control back to the Primary-Process item 6310 in FIG. 6000.
Establish the Target State of the in-scope SG&A function/domain through the use of its constituent Dimensions, Utilities, Stages, Capability categories and Function-Components as well as through the invocation of Extension Frameworks as appropriate, as embodied by item 6320 in FIG. 6000.
Establish Performance Gaps between the Current State and Target State of the in-scope SG&A function/domain through the use of its constituent Dimensions, Utilities, Stages, Capability categories and Function-Components as well as through the invocation of Extension Frameworks as appropriate, as embodied by item 6330 in FIG. 6000.
Develop a new Enterprise Performance Transformation Roadmap for the SG&A function/domain or alternately update one that is currently being used, through the use of its constituent Dimensions, Utilities, Stages, Capability categories and Function-Components as well as through the invocation of Extension Frameworks as appropriate, as embodied by item 6340 in FIG. 6000.
Deploy Internal Capabilities such as a Performance Transformation Maturity Model and related competencies, to improve the maturity of the SG&A function or domain to accelerate its performance transformation competency through the use of its constituent Dimensions, Utilities, Stages, Capability categories and Function-Components as well as through the invocation of Extension Frameworks as appropriate, as embodied by item 6350 in FIG. 6000.
Deploy External Capabilities such as through outsourcing partnerships to improve the maturity of the SG&A function or domain to accelerate its performance transformation competency through the use of its constituent Dimensions, Utilities, Stages, Capability categories and Function-Components as well as through the invocation of Extension Frameworks as appropriate, as embodied by item 6360 in FIG. 6000.
Deploy various capabilities to enhance and assimilate knowledge and skills within the UNIT and or the SG&A domain through the use of its constituent Dimensions, Utilities, Stages, Capability categories and Function-Components as well as through the invocation of Extension Frameworks as appropriate, as embodied by item 6370 in FIG. 6000.
Measure the State Of Performance of the process and of the various parameters utilized for such purposes, such as scorecards, through the use of its constituent Dimensions, Utilities, Stages, Capability categories and Function-Components as well as through the invocation of Extension Frameworks as appropriate, as embodied by item 6380 in FIG. 6000.
Compare the State Of Performance with pre-determined or periodically determined targets to use the feedback to adjust the course and speed of the process underway via a mechanism embodied by item 6410 in FIG. 6000 and also to calibrate against the ‘Strategy’ requirements embodied by item 51 in FIG. 50, through the use of its constituent Dimensions, Utilities, Stages, Capability categories and Function-Components as well as through the invocation of Extension Frameworks as appropriate.

The Primary-Process-flow continues to lead the end-to-end Enterprise Performance Transformation of the UNIT SG&A Function/domain.

The activities associated with the process covered herein can consume between a few days to a few months to several years to reach completion, depending on the nature and complexity of UNIT, the SG&A function/domain and the Enterprise Performance Transformation involved.

What is claimed is:

1. A system to achieve “Enterprise Performance Transformation” in business enterprises, the system comprising:
One Primary-Process for Enterprise Performance Transformation that includes at least one embodiment of process-method and optionally one or a plurality of embodiments of descendent secondary-processes, and initiates, represents the strategic and operational requirements of, and provides the overarching and end-to-end sequence and direction for such Transformation;
One Framework-of-Frameworks that includes one Keystone Framework, embodies and manifests in aggregate the tangible and intellectual-property artifacts utilized to derive capabilities to orchestrate the steps associated with end-to-end Enterprise Performance Transformation;
One Keystone Framework that receives its directions from the Primary-Process and manifests in aggregate the assembly of, either or all of, one or a plurality of Dimensions, one or a plurality of Utilities, one or a plurality of Roll-out Stages, one or a plurality of Capability Categories, and one or a plurality of Function-components, and drives and governs the actual mechanisms and orchestrations of the steps associated with end-to-end Enterprise Performance Transformation, including inclusion of pertinent Extension Frameworks as appropriate;
At least one Extension Framework, with an embodiment of representative Framework each, for Domain Decomposition, Performance Calibration, Transformation Maturity and Performance Optimization, each such Extension Framework affiliated with the Keystone Framework at the behest of the Primary-Process or secondary-processes and wherein the Extension Framework performs one or a plurality of Operations at the express request and direction of the Keystone Framework;
At least one procedure to assemble the specific configuration involving the aggregation of the embodiments of Primary-Process, the Keystone Framework, requisite secondary-processes, Extension Frameworks, requisite customizations, extensions and alterations to each, integration of all embodiments amongst each other and with the Strategy and Systems structures of the Business enterprise and that of the relevant SG&A functions/domains;
At least one process-method in association with the embodiment of either the Primary-Process or a secondary process, each process-method involving the embodiment of at least one process-method-step to manifest the objective(s) of the process-method;
At least one process-method-step in association with the embodiment of a process-method, the step involving the influencing of the state of its subject of action, either in the form of an examination, alteration, communication or all of these;
One or a plurality Optional, secondary processes, each such embodiment of secondary-process spawned either by an ancestral secondary-process or a Primary-Process;
At least one scripted realization-method to realize the embodiment of the Primary-Process, Secondary-Processes, A process-method or a process-method-step to invoke the Keystone Framework as required, during the end-to-end Enterprise Transformation Process;
At least one embodiment of scripted realization-methods for the Keystone Framework to invoke one or a plurality of Extension Frameworks as required, during the end-to-end Enterprise Transformation Process;
At least one embodiment of scripted realization-methods to realize communications between system components during the end-to-end Transformation Process;
At least one physical or electronic storage mechanism for all embodiments of text, graphics, instructions, data, images, methods, scripts, inputs, outputs, deliverables, displays and equivalents involved in the System;
At least one mode of presentation of information and user-interaction selected from the group consisting of text, graphics or multi-media form;
Means of generating embodiments of System-to-user interface, such embodiments providing the modes and orchestration for human user to interact with Enterprise Performance Transformation System;
Means of generating embodiments of System-to-System interface, such embodiments providing the modes and orchestration for one or parts of one Enterprise Performance Transformation System to interact with additional Enterprise Performance Transformation Systems or parts thereof; and
Means for Generating Scripted Methods.
In association with claim 1, a scripted method for customizing the Primary-Process, the method comprising:
a. Identifying the UNIT environment wherein the Enterprise Performance Transformation System is to be employed.
b. Identifying the SG&A function/domains wherein the Enterprise Performance Transformation System is to be deployed.
c. Identifying the Strategy drivers causing the requirement for use of the Enterprise Performance Transformation System.
d. Identifying specific considerations to be included and excluded in the end-to-end transformation process.
e. Developing a new Primary-Process if required, else modifying, altering or adjusting an existing Primary-Process to provide the overall flow-structure for the end-to-end transformation process.
f. Developing one or a plurality of new secondary-processes if required, else modifying, altering or adjusting one or a plurality of existing secondary-processes to provide the overall flow-structure for the Primary-Process being supported.
g. Organizing the Framework-of-Frameworks required to manifest the end-to-end process.
h. Utilizing one or a plurality of apparatuses to actualize the undertaking.
In association with claim 1, a scripted method for configuring the Framework-of-Frameworks, the method comprising:
a. Assembling a base or starter version of the Framework-of-Frameworks with sufficient complement of features and capabilities.
b. Including features and capabilities required by the Primary-Process and secondary-processes to fulfill the requirements of the end-to-end transformation process.
c. Excluding features and capabilities not required to achieve stated and desired objectives.
d. Supplementing the capabilities of the Framework-of-Frameworks with external, third-party capabilities as called for by the Primary-Process and/or secondary-processes.
e. Utilizing one or a plurality of apparatuses to actualize the undertaking.

4. In association with claim 1, a scripted method for customizing the Keystone Framework, involving:
a. Selecting the Transformation Acceleration Framework from the assembled suite of Framework-of-Frameworks.
b. Confirming that the Framework is appropriately configured to achieve the end-to-end objectives of the Primary-Process and/or secondary-processes.
c. Implementing changes to the Keystone Framework to address shortcomings discovered in (b)
d. Establishing the appropriate ‘Dimensions’ required to achieve end-to-end Enterprise Performance Transformation objectives set forth.
e. Establishing the appropriate ‘Utilities’ for each Dimension to achieve end-to-end Enterprise Performance Transformation objectives set forth.
f. Establishing the appropriate ‘Roll-out Stages’ for each Utility as required to achieve end-to-end Enterprise Performance Transformation objectives set forth.
g. Establishing the appropriate ‘Capability Categories’ required within each roll-out Stage to achieve end-to-end Enterprise Performance Transformation objectives set forth.
h. Establishing the appropriate ‘function-components’ required for each Capability category for each roll-out Stage, to achieve end-to-end Enterprise Performance Transformation objectives set forth.
i. Utilizing one or a plurality of apparatuses to actualize the undertaking.

5. In association with claim 1, a scripted method for validating and customizing each Extension Framework, the method entailing:
a. Selecting an Extension Framework from the assembled suite of Framework-of-Frameworks.
b. Confirming that the Extension Framework is appropriately configured to achieve the end-to-end objectives of the primary and secondary Processes.
c. Implementing changes to the Extension Framework to address shortcomings discovered in (b).
d. Repeating steps (a), (b) and (c) for each of the Extension Frameworks in the assemblage.
e. Performing the appropriate actions to each Extension Framework to tailor it to work adequately with the Keystone Framework and other Extension Frameworks
f. Utilizing one or a plurality of apparatuses to actualize the undertaking.

6. In association with claim 1, a scripted method for organizing and integrating the specific embodiment of a Enterprise Performance Transformation System configuration, with ALL components, involving:
a. Ensuring finalization of the Primary-Process, the Keystone Framework, requisite secondary-processes, Extension Frameworks, requisite customizations, extensions and alterations to each, integration of all embodiments amongst each other and with the Strategy and Systems structures of the Business enterprise and that of the relevant SG&A functions.
b. Establishing the appropriate mechanisms to manifest the final suite in item (a).
c. Testing the inter-operability of items in (a) via embodiments of mechanisms present in (b).
d. Utilizing one or a plurality of apparatuses to actualize the undertaking.

7. In association with claim 1, a scripted method for customizing the embodiment of the Process-Methods in both the Primary-Process and associated secondary-processes, including process steps, involving:
a. Beginning with the Primary-Process and secondary-processes already approved and customized for the end-to-end transformation.
b. For embodiments of each process-step in the Primary-Process, defining the method to execute the process step and confirm availability of required Frameworks, artifacts, data, and other material and also viability of operation; making changes as appropriate.
c. For embodiments of each process-step in the secondary-Processes, defining the method to execute the process-step and to confirm availability of required Frameworks, artifacts, data, and other material and also viability of operation; making changes as appropriate.
d. Utilizing one or a plurality of apparatuses to actualize the undertaking.

8. In association with claim 1, a scripted method for invoking the embodiment of Keystone Framework from within the embodiment of the Primary-Process, the method comprising:
a. Beginning with the embodiment of the finalized Primary-Process.
b. Initiating the steps in the process flow pertaining to the embodiment of UNIT Strategy criteria and triggers causing the need for Enterprise Performance Transformation.
c. Causing the step or steps associated with (b) to invoke the embodiment of the first Utility in the Keystone Framework, the Transformation Acceleration Framework.
d. Utilizing one or a plurality of apparatuses to actualize the undertaking.

9. In association with claim 1, a scripted method for invoking the embodiments of one or a plurality of Extension Frameworks, involving:
a. Commencing the end-to-end transformation process by first initiating the Keystone Framework via the Primary-Process.
b. The Keystone Framework initiating the use of a ‘Utility’ as part of a ‘Dimension’ and informing the Primary-Process of its progress.
c. The Primary-Process providing validation and go-ahead to invoke an Extension Framework to obtain its services.
d. Utilizing one or a plurality of apparatuses to actualize the undertaking.

10. In association with claim 1, a scripted method for establishing and customizing embodiments of several Communications interactions involved in the end-to-end transformation process, involving:
a. Ensuring a full understanding of all the communications needs involved in the embodiment of the end-to-end transformation process via review of the Primary-Process details and secondary-process details.
b. Ensuring a full understanding of all the communications needs involved in and associated with, embodiments of each of the Frameworks employed in the end-to-end transformation process.
c. Ensuring a full understanding of all the communications needs involved in receiving inputs from the embodiment of the ‘Strategy’ structure of the UNIT and for contributing outputs to the same.
d. Implementing appropriate mechanisms to embody and manifest each of the requirements in (a), (b) and (c)
e. Utilizing one or a plurality of apparatuses to actualize the undertaking.

11. In association with claim 1, an apparatus for customizing Primary-Process and its secondary-processes, such apparatus comprising:
a. One or a plurality of sources of instruction, guidance, inputs or other directives to initiate the end-to-end Enterprise Performance Transformation process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

12. In association with claim 11, computer-readable memory comprising computer-executable instructions that when executed, cause:
a. Access to and use of one or a plurality of sources of instruction, guidance, inputs or other directives to initiate the end-to-end Enterprise Performance Transformation process, including portions thereof.
b. Access to and use of, one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

13. In association with claim 1, an apparatus for organizing and customizing the Framework of Frameworks, such apparatus comprising:
a. One or a plurality of sources of instruction, guidance, inputs or other directives to initiate the process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

14. In association with claim 13, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

15. In association with claim 1, an apparatus for customizing the Keystone Framework, such apparatus comprising:
a. One or a plurality of sources of instruction, guidance, inputs or other directives to initiate the end-to-end process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

16. In association with claim 15, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

17. In association with claim 1, an apparatus for customizing the Extension Frameworks, such apparatus comprising:
a. One or a plurality of sources of instruction, guidance, inputs or other directives to initiate the process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

18. In association with claim 17, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

19. In association with claim 1, an apparatus for establishing and customizing specific system configuration, such apparatus comprising:
a. One or a plurality of sources of instruction, guidance, inputs or other directives to initiate the process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

20. In association with claim 19, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

21. In association with claim 1, an apparatus for organizing and customizing Process Methods, including its steps, such apparatus comprising:
a. One or a plurality of sources of instruction, guidance, inputs or other directives to initiate the process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

22. In association with claim 21, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

23. In association with claim 1, an apparatus for invoking the Keystone Framework, such apparatus comprising:
a. One or a plurality of sources of instruction, guidance, inputs or other directives to initiate the process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

24. In association with claim 23, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

25. In association with claim 1, an apparatus for invoking Extension Frameworks, such apparatus comprising:
a. One or a plurality of sources of instruction, guidance, inputs or other directives to initiate the process, including portions thereof
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

26. In association with claim 25, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.

27. In association with claim 1, an apparatus for establishing and fine-tuning Communications, such apparatus comprising:
a. One or a plurality of sources of instruction, guidance, inputs or other directives to initiate the process, including portions thereof.
b. One or a plurality of repositories for the artifacts, required to manifest all actions entailed.
c. One or a plurality of mechanisms to access, deposit, interact with, save or otherwise manipulate the material in the repository/repositories as needed.
d. One or a plurality of mechanisms to create, delete, modify or otherwise alter the artifacts to ready them for use as required within the end-to-end transformation process.

28. In association with claim 27, computer-readable memory comprising computer-executable instructions that when executed, cause:
a. Access to and use of one or a plurality of sources of instruction, guidance, inputs or other directives to initiate the process, including portions thereof.
b. Access to and use of one or a plurality of repositories for the artifacts, required to manifest all actions entailed.
c. Availability and operation of one or a plurality of mechanisms to access, deposit, interact with, save or otherwise manipulate the material in the repository/repositories as needed.
d. Availability and operation of one or a plurality of mechanisms to create, delete, modify or otherwise alter the artifacts to ready them for use as required within the end-to-end transformation process.
